(19) United States
(12) Patent Application Publication
(10) Pub. No.: US 2025/0125914 A1
(43) Pub. Date: Apr. 17, 2025

(54) SYSTEM AND METHOD FOR INCREASING CAPACITY OF COMMUNICATION CHANNELS IN A NETWORK

(71) Applicant: Tejas Networks Ltd., Bangalore (IN)

(72) Inventor: Vinod Kumar MADAIAH, Bangalore (IN)

(73) Assignee: Tejas Networks Ltd., Bangalore (IN)

(21) Appl. No.: 18/911,550

(22) Filed: Oct. 10, 2024

(30) Foreign Application Priority Data
Oct. 13, 2023 (IN) 202341069101

(51) Int. Cl. H04L 5/00

(52) U.S. Cl. CPC H04L 5/001; H04L 5/0064; H04L 5/0094

(57) ABSTRACT

The present disclosure provides a system and a method for increasing capacity of communication channels in a network. The system distributes power across one or more subcarriers by varying a phase and an amplitude of the one or more subcarriers over a predetermined period. The system determines one or more waveforms associated with the one or more subcarriers to be transmitted based on the distributed power. The system maps a block of bits received from a bit stream, with each of the one or more waveforms and records the mapping.

### CROSS-REFERENCE TO RELATED APPLICATION

This application is based upon and claims the benefit of priority from Indian Patent Application number 202341069101, filed Oct. 13, 2023, the entire contents of which are incorporated herein by reference.

### FIELD OF INVENTION

The embodiments of the present disclosure generally relate to a field of wireless networks. More particularly, the present disclosure relates to a system and a method for increasing capacity of communication channels in a network.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In general, capacity is defined as a maximum rate at which data or information is transmitted over a noisy channel without errors. The capacity is measured in bits per second. In conventional systems, the capacity or the information rate may be maximized under a power constraint. Further, conventional systems may use a set of user data rates and attempt to minimize total transmit power under a fixed performance requirement. However, conventional systems may experience shortcomings in minimizing the total transmit power and maximizing the capacity of wireless channels.

There is, therefore, a need in the art to provide an improved system and a method to increase the capacity of the communication channels by overcoming the deficiencies of the prior art(s).

### OBJECTS OF THE INVENTION

Some of the objects of the present disclosure, which at least one embodiment herein satisfies are listed herein below.

It is an object of the present disclosure to provide a system and a method for increasing a capacity of communication channels in a network.

It is an object of the present disclosure to distribute total/available power across one or more sub-carriers to increase the capacity of a communication channel in the network.

It is an object of the present disclosure to provide a system and a method that distributes power across one or more subcarriers by varying a phase and an amplitude of one or more subcarriers over a predetermined period.

It is an object of the present disclosure to provide a system and a method that determines one or more waveform combinations associated with one or more subcarriers based on the distributed power.

It is an object of the present disclosure to provide a system and a method that maps a block of bits from a received bit stream with each of one or more waveforms of a waveform combination and determines a combinatorial capacity of the communication channel.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a method for determining a combinatorial capacity of a communication channel. The method includes distributing power across one or more subcarriers by varying a phase and an amplitude of the one or more subcarriers over a predetermined period. The method includes determining one or more waveforms associated with the one or more subcarriers based on the distributed power. The method includes mapping a block of bits from a received bit stream with each of the one or more waveforms of a waveform combination, where the waveform combination is selected among predetermined waveform combinations and recording the mapping.

In an embodiment, the method may include receiving the bit stream. The method may include identifying the block of bits from the received bit stream. The method may include selecting, a waveform among the one or more waveforms to be transmitted based on the block of bits. The method may include matching, all the waveforms of the waveform combination with a received waveform. The method may include selecting, a waveform from a waveform combination. The method may include determining a combinatorial capacity of the communication channel based on the selection of the waveform combination.

In an embodiment, the method may include modulating a subcarrier among the one or more subcarriers into an in-phase component and a quadrature-phase component and utilizing the in-phase component and the quadrature-phase component of the subcarrier over the predetermined period for generating the one or more waveforms.

In an embodiment, the method may include determining a capacity of the communication channel by determining a base two logarithmic value of the total number of waveforms in the waveform combination.

In an aspect, a system for determining a combinatorial capacity of a communication channel includes a processor communicatively coupled to a transceiver of the system. A memory is operatively coupled with the processor, wherein said memory stores instructions which, when executed by the processor cause the processor to distribute power across one or more subcarriers by varying a phase and an amplitude of the one or more subcarriers over a predetermined period. The processor determines one or more waveforms associated with the one or more subcarriers to be transmitted based on the distributed power. The processor maps a block of bits received from a bit stream, with each of the one or more waveforms and records the mapping.

In an embodiment, the processor may be configured to receive the bit stream via a transmitter configured with the transceiver. The processor may be configured to identify the block of bits from the received bit stream. The processor may be configured to select, a waveform among the one or more waveforms to be transmitted based on the block of bits. The processor may be configured to match, via a receiver, all the waveforms of the one or more waveforms used at the transmitter with a received waveform. The processor may be configured to select, at the receiver configured with the transceiver, a waveform from a waveform combination. The processor may be configured to determine a combinatorial capacity of the communication channel based on the selection of the waveform combination.

In an embodiment, the processor may be configured to modulate a subcarrier among the one or more subcarriers into an in-phase component and a quadrature-phase component and utilize the in-phase component and the quadrature-phase component of the subcarrier over the predetermined period for generating the one or more waveforms.

In an embodiment, the processor may be configured to determine a capacity of the communication channel in the transceiver by determining a base two logarithmic value of the total number of waveforms in the waveform combination.

In an aspect, a non-transitory computer readable medium includes a processor with executable instructions, causing the processor to distribute power across one or more subcarriers by varying a phase and an amplitude of the one or more subcarriers over a predetermined period. The processor determines one or more waveforms associated with the one or more subcarriers to be transmitted based on the distributed power. The processor maps a block of bits received from a bit stream, with each of the one or more waveforms and record the mapping.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example system architecture (100) for implementing a proposed system (102), in accordance with an embodiment of the present disclosure.

FIG. 2 illustrates an example block diagram (200) of a proposed system (102), in accordance with an embodiment of the present disclosure.

FIG. 3 illustrates an example representation depicting a combinatorial capacity gain plot, in accordance with an embodiment of the present disclosure.

FIGS. 4A-4F illustrate exemplary waveform generation (400) by the proposed system (102), in accordance with embodiments of the present disclosure.

FIG. 5 illustrates an example computer system (500) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Long-Term Evolution (LTE) is used with user equipments (UEs), because of priority services, high data rate, low latency, etc. LTE uses orthogonal frequency division multiplexing (OFDM) for downlink transmissions because it meets the necessity of LTE-like range flexibility and empowers the cost gainful responses for the wide carriers. LTE offers big-data values, allows spectrum refarming, reduces cost, etc. The present disclosure describes a system and a method for increasing capacity of communication channels in a network.

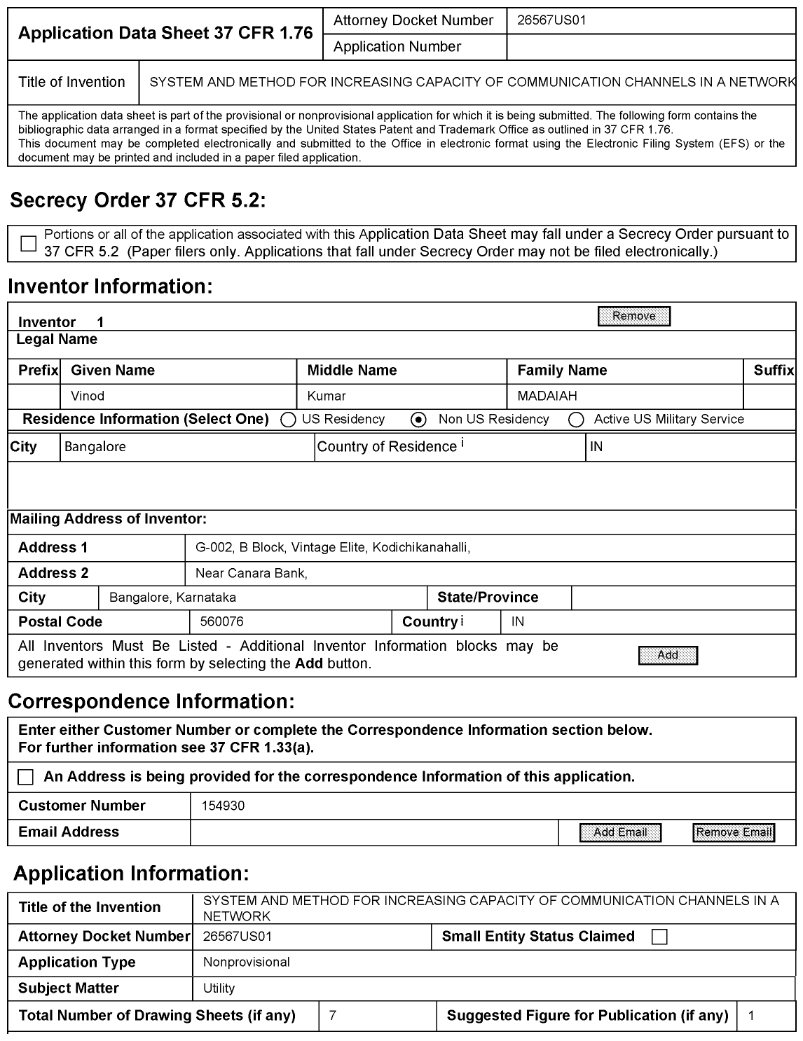

Various embodiments of the present disclosure will be explained in detail with reference to FIGS. 1-5.

FIG. 1 illustrates an example system architecture (100) for implementing a proposed system (102), in accordance with an embodiment of the present disclosure.

In an embodiment, the system (102) may receive a bit stream via a transmitter configured with the system (102). A person skilled in the art may understand that the system (102) may include a transceiver. The system (102) may receive the bit stream and may include a computing device.

In an embodiment, the system (102) may distribute power across one or more subcarriers by varying a phase and an amplitude of the one or more subcarriers over a predetermined period. The system (102) may determine one or more waveforms associated with the one or more subcarriers to be transmitted based on the distributed power. Further, the system (102) may map the block of bits received from the bit stream, with each of the one or more waveforms and record the mapping. There may be many waveform combinations possible for example, 8 waveforms may be chosen out of 13 waveforms, i,e factorial(13)/[factorial(8)*factorial(13−8)]=1287). For example, any 8 waveforms from the 13 waveforms may be selected and recorded as a first combination. Further, another set of 8 waveforms, with at least one waveform different from the first combination may be selected and recorded as a second combination. This way many other combinations may be recorded. Hence, one waveform may be transmitted from predetermined waveform combination, agreed between a transmitter and a receiver. The system (102) may identify the block of bits from the received bit stream and group the block of bits into N bits based on the one or more waveforms.

In an embodiment, the system (102) may match, via a receiver configured with the system (102), with all the waveforms of the one or more waveforms used at the transmitter with a received waveform. Further, the system (102) may select, via the receiver, a waveform from a waveform combination after matching a maximum correlation using one or more correlators (also known as correlator bank) with one or more threshold or level-detectors. The system (102) may select, via the receiver, a waveform from a waveform combination with a Minimum Euclidean-Distance or a template matching. The system (102) may select, via the receiver, a waveform from a waveform combination with an Optimal detector or a Maximum Likelihood (ML) detector or a Maximum A-priori Probability detector (MAP) or a Minimum Probability of Error (MPE) detector, etc. or a combination thereof. Hence, the system (102) may determine a combinatorial capacity of a communication channel in the transceiver/system (102) based on the selection of the waveform combination

As illustrated in FIG. 1, the system (102) may receive the bit stream (104) via the transmitter. The system (102) may generate the block of bits from the received bit stream. The system (102) may group (104) the block of bits into N bits. Further, the system (102) may select (106) the waveform among the one or more waveforms to be transmitted based on the N bits. The system (102) may add cyclic prefix (108) to the waveform to combat fading. Furthermore, the system (102) may transmit the waveform to the receiver, where the system (102) may remove the cyclic prefix (110). The system (102) may match (112) all the waveforms of the waveform combination used at the transmitter with a received waveform in the receiver. The system (102) may select (114), at the receiver, a waveform from a waveform combination after matching with a maximum correlation using one or more correlators (also known as correlator bank) with one or more threshold or level-detectors. The system (102) may select, via the receiver, a waveform from a waveform combination with a Minimum Euclidean-Distance or a template matching. The system (102) may select, via the receiver, a waveform from a waveform combination with an Optimal detector or a Maximum Likelihood (ML) detector or a Maximum A-priori Probability detector (MAP) or a Minimum Probability of Error (MPE) detector, etc. or a combination thereof. The system (102) may declare (116) a bit estimate based on the selection of the waveform combination.

In an embodiment, the system (102) may be configured to modulate a subcarrier among the one or more subcarriers into an in-phase component and a quadrature-phase component and utilize the in-phase component and the quadrature-phase component of the subcarrier over the predetermined period for generating the one or more waveforms.

In an embodiment, the system (102) may be configured to determine a capacity of the communication channel in the transceiver by determining a base two logarithmic value of the total number of waveforms in the waveform combination.

In an embodiment, the computing device may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like, example underwater acoustic communication. In an embodiment, the computing device may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as a camera, an audio aid, a microphone, a keyboard, and input devices for receiving input from the user or the entity such as touch pad, touch enabled screen, electronic pen, and the like. A person of ordinary skill in the art may appreciate that the computing device may not be restricted to the mentioned devices and various other devices may be used.

In an embodiment, for example, two orthogonal sub-carriers may be considered with the system (102). Bandwidth used by the two sub-carriers may be 2×15 Kilohertz (kHz). A sub-carrier modulation with a BPSK symbol and a Nyquist rate may be assumed, i.e., the sub-carriers having 15 kHz bandwidth may convey 15 k symbols. Therefore, a capacity and an OFDM symbol duration may be defined as follows:

$$Capacity = 2 \times 15 k \times 1 = 30 kbps \qquad ( 1 )$$

Where, 2 denotes sub-carriers, 15 k denotes Nyquist symbols per sub-carrier and 1 bit per BPSK symbol.

$$OFDM symbol duration = \frac{1}{15 k} = 66.7 μs \qquad ( 2 )$$

Therefore, bits conveyed using 2 subcarriers over one OFDM

$$symbol duration = 30 kHz \times 66.7 μs = 2 bits \qquad ( 3 )$$

Further, the Shannon capacity may be given by:

$$C = B \times {log}_{2} ( 1 + \frac{P}{N} ) bps \qquad ( 4 )$$

Where, B is the bandwidth used by the two sub-carriers, (P/N) is the signal to noise ratio.

Each sub-carrier may be demodulated independently and all the sub-carriers may be orthogonal to each other. The present disclosure considers combinatorics and counts the symbols per sub-carrier. When both the sub-carriers are used, four symbols, for example, 00, 01, 10, and 11 may be transmitted.

When only the first sub-carrier is used and the second sub-carrier is not used, a detection mechanism or hypothesis testing may be utilized to determine the presence of the first sub-carrier and the absence of the second sub-carrier, such that two symbols, for example, 0_ and 1_ may be possibly transmitted. Decision statistics on the received sample, such as mean and variance, may be different when the signal S(t) is present on the sub-carrier ˜N (∥S∥², σ²∥S∥²) versus when the signal is absent on the sub-carrier ˜N (0, σ²). These statistics may be checked for optimal demodulation.

Similarly, when only the second sub-carrier is used and when the first sub-carrier is not used, two symbols, for example, _0 and _1 may be transmitted.

Finally, when both the sub-carriers are not used, one symbol, for example, _ _ may be transmitted. Therefore, in total, 4+2+2+1=9 symbols are utilized.

Capacity per channel use may be defined as follows:

$$Capacity per channel use = {log}_{2} ( 9 ) = 3.17 bits \qquad ( 5 )$$

$$which is \frac{3.17 - 2}{2} = \frac{1.17}{2} = 0.585 = 58.5 \% increase per channel use .$$

If the number of subcarriers is N, bandwidth occupied per sub-carrier is Bₛ, then for BPSK,

Combinatorial capacity=Bₛ log(1+2)^{N}=NBₛ log₂(3)=B log₂ 3=1.585 B=58.5% more capacity, where B=NBₛ is the total bandwidth.

The combinatorial capacity is independent of N and improvement is always 58.5%.

This may result in ˜60% increase in capacity, ˜60% decrease in power or PAPR, and ˜60% reduced spectral usage.

In another embodiment, the present disclosure uses one sub-carrier and two symbol duration instead of combinations over the sub-carriers. In another embodiment, the present disclosure uses in-phase and quadrature-phase (I-phase and Q-phase components) sub-carriers, rather than using two sub-carriers (or two symbol durations).

In an absence of the sub-carrier in combination with BPSK modulation, the symbol may be a 3-level modulation symbol, i.e., {−1, 0, +1}, increasing susceptibility to noise and therefore marginally reduced channel capacity (e.g. a capacity increase of 50% instead of 58.5%) for the required coding gain. The level ‘0’ denotes absence of sub-carrier. The symbol may also be a complex symbol.

The combinatorial capacity may be defined as follows:
If there are 2 levels per dimension, then

$$Capacity = {B}_{s} {log ( 1 + 2 )}^{N} \qquad ( 6 )$$

If there are L levels per dimension, then

$$Capacity = {B}_{s} {log ( 1 + L )}^{N} = N {B}_{s} log ( 1 + L ) = B {log}_{2} ( 1 + L ) \qquad ( 7 )$$

Where, one (1) within the bracket in the term (1+L) corresponds to a level zero or transmitting nothing increasing susceptibility to noise and therefore marginally reduced channel capacity (e.g. a capacity increase of 50% instead of 58.5%) for the required coding gain. It is noted that an improvement in capacity diminishes logarithmically as L increases and becomes equal to a Shannon limit. A similar computation with absence of level zero, i.e., all subcarriers always present, can be performed wherein the capacity will be less due to lesser number of available combinations. It should be noted that voltage levels have to be associated with appropriate voltages (in Volts) depending on the channel encodings, dispersion and noise.

Although FIG. 1 shows exemplary components of the network architecture (100), in other embodiments, the system architecture (100) may include fewer components, different components, differently arranged components, or additional functional components than depicted in FIG. 1. Additionally, or alternatively, one or more components of the system architecture (100) may perform functions described as being performed by one or more other components of the system architecture (100).

FIG. 2 illustrates an example block diagram (200) of a proposed system (102), in accordance with an embodiment of the present disclosure.

Referring to FIG. 2, the system (102) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (102). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (102) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (102). Examples of such components include, but are not limited to, processing engine(s) (208) and a database (210). In an embodiment, the other engine(s) (214) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (102) may comprise the machine-readable storage medium storing the instructions and the processing resource to execute the instructions, or the machine-readable storage medium may be separate but accessible to the system (102) and the processing resource. In other examples, the processing engine(s) (208) may be implemented by electronic circuitry.

In an embodiment, the processor (202) may receive the bit stream via a transmitter configured with the transceiver. The processor (202) may identify the block of bits from the received bit stream. The processor (202) may select, a waveform among one or more waveforms to be transmitted based on the block of bits. The processor (202) may match, via a receiver, all the waveforms of the one or more waveforms used at the transmitter with a received waveform. The processor (202) may select, at the receiver configured with the transceiver, a waveform from a waveform combination. The processor (202) may select, via the receiver, a waveform from a waveform combination after matching a maximum correlation using one or more correlators (also known as correlator bank) with one or more threshold or level-detectors. The processor (202) may select, via the receiver, a waveform from a waveform combination with a Minimum Euclidean-Distance or a template matching. The processor (202) may select, via the receiver, a waveform from a waveform combination with an Optimal detector or a Maximum Likelihood (ML) detector or a Maximum A-priori Probability detector (MAP) or a Minimum Probability of Error (MPE) detector, etc. or a combination thereof. The processor (202) may determine a combinatorial capacity of the communication channel based on the selection of the waveform combination.

In an embodiment, the processor (202) may receive the bit stream via a transmitter configured with the transceiver. The processor (202) may identify the block of bits from the received bit stream. The processor (202) may select, the waveform among the one or more waveforms to be transmitted based on the block of bits. The processor (202) may match, via a receiver, all the waveforms of the one or more waveforms used at the transmitter with a received waveform. The processor (202) may select, at the receiver configured with the transceiver, a waveform from a waveform combination. The processor (202) may determine a combinatorial capacity of the communication channel based on the selection of the waveform combination.

In an embodiment, the processor (202) may modulate a subcarrier among the one or more subcarriers into an in-phase component and a quadrature-phase component and utilize the in-phase component and the quadrature-phase component of the subcarrier over the predetermined period for generating the one or more waveforms.

In an embodiment, the processor (202) may determine a capacity of the communication channel in the transceiver by determining a base two logarithmic value of the total number of waveforms in a waveform combination.

Although FIG. 2 shows exemplary components of the system (108), in other embodiments, the system (102) may include fewer components, different components, differently arranged components, or additional functional components than depicted in FIG. 2. Additionally, or alternatively, one or more components of the system (102) may perform functions described as being performed by one or more other components of the system (102).

FIG. 3 illustrates an example representation depicting a combinatorial capacity gain plot, in accordance with an embodiment of the present disclosure.

With reference to FIG. 3, a power amplifier (or an amplifier) may be utilized by the system (102) for a peak-to-peak voltage swing. If peak-to-peak voltage swings from −L to +L (there are 2L+1 levels), then power may swing from 0 to L\hat{ }2 (there are L+1 levels). Therefore, the present disclosure may distribute the power, say L\hat{ }2 watts, over the one or more subcarriers. By distributing the power over the one or more subcarriers, the capacity may be improved, for example, to 114% when the number of subcarriers is 5 and using BPSK modulation because (10.7168−5)/5=1.14336=˜114%. The combinatorial capacity gain plot may be as depicted in FIG. 3. This plot is noted to be diverging or exponentially increasing and may suggest that there is increasing capacity as the number of sub-carriers increases. This may be seen from the gain in capacity: when the number of subcarriers is 2, the gain is equal to (3.7005−2)/2=1.7005/2=0.85025=˜85%, which is less than the gain for 5 sub-carriers, i.e., ˜114%. Therefore, increasing an LTE capacity, a milli-meter wave capacity, an underwater acoustic channel capacity, and a dense wavelength division multiplexing (DWDM) capacity.

FIGS. 4A-4F illustrate exemplary waveform generation (400) by the proposed system (102), in accordance with embodiments of the present disclosure.

As illustrated in FIGS. 4A-4F, the system (102) may distribute power across one or more subcarriers by varying a phase and an amplitude of the one or more subcarriers over a predetermined period. Further, the system (102) may generate one or more waveforms associated with the one or more subcarriers to be transmitted based on the distributed power.

For example, in an embodiment, as shown in FIG. 4A, the capacity of a communication channel in a transceiver i, e, the capacity per channel use (N) bits=log₂(M). Here M is the total number of waveforms generated based on the distribution of power across two subcarriers among the one or more subcarriers. Considering two subcarriers, FIG. 4A represents no waveform (waveform 1) for time period T₀. FIG. 4B represents use of one subcarrier at a frequency f₀ to generate a waveform 2 for time period T₀. FIG. 4C represents use of one subcarrier at a frequency 2f₀, i, e one subcarrier over one symbol duration to generate a waveform 3 for time period T₀. FIG. 4D represents the sum of waveforms 2 and 3, i, e waveform 4. Similarly, FIG. 4E includes generation of waveform 5 using one subcarrier of frequency f₀ with twice the amplitude/voltage. FIG. 4E includes generation of waveform 6 using one subcarrier of frequency 2f₀ with twice the amplitude/voltage. Similarly, waveform 7 may be negative of waveform 2, waveform 8 may be negative of waveform 3. Also, waveform 9 may be negative of waveform 4 and waveform 10 may be negative of waveform 5. A waveform 11 may be negative of waveform 6. A waveform 12 may be formed by subtracting waveform 3 from waveform 2 (waveform 2 minus waveform 3) and a waveform 13 may be negative of waveform 12. There are thirteen waveforms possible.

Hence, the total number of waveforms is equal to 13, or capacity per channel use (N) bits=log₂(M), log₂(13)=3.7 bits. Using round off, 2³=8, means 8 out of the 13 waveforms may be selected for transmission. This selection may be based on but not limited to a mean, a peak voltage, a Peak to Average Power Ratio (PAPR), and a variance.

For example, Table 1 shows mapping of bits with the 8 waveforms.

TABLE 1

| | | | Waveform |
|---|---|---|---|
| b₂ | b₁ | b₀ | Number |
| 0 | 0 | 0 | 1 |
| 0 | 0 | 1 | 2 |
| 0 | 1 | 0 | 3 |
| 0 | 1 | 1 | 4 |
| 1 | 0 | 0 | 5 |
| 1 | 0 | 1 | 6 |
| 1 | 1 | 0 | 7 |
| 1 | 1 | 1 | 8 |

Hence, using two subcarriers and distributing power across the subcarriers, the system (102) may be capable to increase the generation of a number of unique waveforms. Further, taking log₂ (waveforms), N_{bits} to be transmitted may be determined with a higher data rate. The data rate may be higher by ((3.7−2)/2)=85% increase in the channel capacity using the M waveforms.

FIG. 5 illustrates an exemplary computer system (500) in which or with which embodiments of the present disclosure may be implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method for increasing a capacity of communication channels in a network.

The present disclosure provides a system and a method that distributes total/available power across one or more sub-carriers to increase the capacity of the communication channel in the network.

The present disclosure provides a system that uses the one or more sub-carriers to generate one or more unique waveforms for transmitting data through the communication channel.

The present disclosure provides a system and a method that increases a Long-Term Evolution (LTE) capacity, a milli-meter wave capacity, an underwater acoustic channel capacity, and a dense wavelength division multiplexing (DWDM) capacity.

1. A method for determining a combinatorial capacity of a communication channel, the method comprising:
distributing power across one or more subcarriers by varying a phase and an amplitude of the one or more subcarriers over a predetermined period;
determining one or more waveforms associated with the one or more subcarriers based on the distributed power; and
mapping a block of bits from a received bit stream with each of the one or more waveforms of a waveform combination, wherein the waveform combination is selected among predetermined waveform combinations and recording the mapping.

2. The method as claimed in claim 1, wherein the method comprises:
receiving the bit stream;
identifying the block of bits from the received bit stream;
selecting, a waveform among the one or more waveforms to be transmitted based on the block of bits;
matching, all the waveforms of the waveform combination with a received waveform;
selecting, a waveform from a waveform combination; and
determining a combinatorial capacity of the communication channel based on the selection of the waveform combination.

3. The method as claimed in claim 1, comprising modulating a subcarrier among the one or more subcarriers into an in-phase component and a quadrature-phase component and utilizing the in-phase component and the quadrature-phase component of the subcarrier over the predetermined period for generating the one or more waveforms.

4. The method as claimed in claim 1, comprising determining a capacity of the communication channel by determining a base two logarithmic value of the total number of waveforms in the waveform combination.

5. A system for determining a combinatorial capacity of a communication channel, the system comprising:
a processor communicatively coupled to a transceiver of the system;
a memory operatively coupled with the processor, wherein said memory stores instructions which, when executed by the processor, cause the processor to:
distribute power across one or more subcarriers by varying a phase and an amplitude of the one or more subcarriers over a predetermined period;
determine one or more waveforms associated with the one or more subcarriers to be transmitted based on the distributed power;
map a block of bits received from a bit stream, with each of the one or more waveforms and record the mapping.

6. The system as claimed in claim 5, wherein the processor is configured to:
receive the bit stream via a transmitter configured with the transceiver;
identify the block of bits from the received bit stream;
select, a waveform among the one or more waveforms to be transmitted based on the block of bits;
match, via a receiver, all the waveforms of the one or more waveforms used at the transmitter with a received waveform;
select, at the receiver configured with the transceiver, a waveform from a waveform combination; and
determine a combinatorial capacity of the communication channel based on the selection of the waveform combination.

7. The system as claimed in claim 5, wherein the processor is configured to modulate a subcarrier among the one or more subcarriers into an in-phase component and a quadrature-phase component and utilize the in-phase component and the quadrature-phase component of the subcarrier over the predetermined period for generating the one or more waveforms.

8. The system as claimed in claim 5, wherein the processor is configured to determine a capacity of the communication channel in the transceiver by determining a base two logarithmic value of the total number of waveforms in the waveform combination.

9. A non-transitory computer readable medium comprising a processor with executable instructions, causing the processor to:
distribute power across one or more subcarriers by varying a phase and an amplitude of the one or more subcarriers over a predetermined period;
determine one or more waveforms associated with the one or more subcarriers to be transmitted based on the distributed power; and
map a block of bits received from a bit stream, with each of the one or more waveforms and record the mapping.
